(19) United States
(12) Patent Application Publication
(10) Pub. No.: US 2010/0070242 A1
(43) Pub. Date: Mar. 18, 2010

(54) METHOD FOR THE COMPUTER-ASSISTED DESIGN OF A MECHANICAL ASSEMBLY

(75) Inventors: Cyril Renault, Menucourt (FR); Herve Colombel, Paris (FR); Arnaud Maupetit, Meaux (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES S.A., Velizy Villacoublay (FR)

(21) Appl. No.: 12/447,436

(22) PCT Filed: Oct. 19, 2007
(86) PCT No.: PCT/FR07/52207

§ 371 Date: Apr. 27, 2009

(30) Foreign Application Priority Data
Oct. 27, 2006 (FR) 0654609

(51) Int. Cl. G06F 17/50; G06T 17/00

(52) U.S. Cl. 703/1

(57) ABSTRACT

The invention relates to a method for the computer-assisted design of a mechanical assembly, that comprises at least: a step of graphic three-dimensional modeling of the mechanical assembly that can be piloted by several elementary solids (SE) that can be parametered at least geometrically by the user independently from each other, each elementary solid comprising a geometric structure that can be at least geometrically parametered by the user and representing a portion of a part or a recess of a portion of a part, a part being a structure in which all the structures are immobile relative to each other, the parametered geometric structures of the elementary solids being generic for several different mechanical assemblies and having the same function, wherein the parametering of said structures can be different from mechanical assembly to the other, while the elementary solids on one hand and the graphic modeling on the other hand are stored in distinct files so that said graphic modeling can still be piloted by said elementary solids and so that the re-use of said generic geometric structures is made easier for the user.

The invention concerns the field of methods for the computer-assisted design, and more particularly to methods for computer-assisted design of a mechanical assembly. Such methods usually include a step of graphic modeling of the mechanical assembly.

According to a prior art, a method for computer-assisted design of a mechanical assembly is known, which is based on the use of a skeleton driving an assembly of elementary solids (SE), which in turn drives a three-dimensional graphical model. For a given mechanical assembly, a same file contains both the parameterizable skeleton of the mechanical assembly, the elementary solids assembled to each other so as to constitute the mechanical assembly, and the three-dimensional graphical model. The skeleton and the elementary solids are specific, i.e., they cannot be separated from the other elements and extracted from the common file, or at least, not easily. A drawback of this prior art is that it requires a design time which is too long overall, because, from one given mechanical assembly to another, distinct given mechanical assembly, wherein both mechanical assemblies fulfill the same function, the whole process must be started again, first, generally, with the skeleton, then possibly with the assembly of the elementary solids, and, if appropriate, with the elementary solids themselves. This possibility of easily re-using the skeleton of a distinct given mechanical assembly with another, distinct given mechanical assembly makes it possible to reduce very significantly the overall design time for several distinct mechanical assemblies that fulfill the same function.

The invention proposes a method for computer-assisted design of a mechanical assembly in which at least the elementary solids are provided generically and stored in a file distinct from that of the graphical model, or in several files each distinct from the graphical model file, so that they can be re-used from a given mechanical assembly to another, distinct given mechanical assembly, as long as the two mechanical assemblies fulfill the same function, while being linked to the graphical model so that the graphical model remains drivable, by the elementary solids, whether the elementary solids are themselves driven directly or indirectly. When they are indirectly driven, which is the most frequent, this can occur, for example, via a skeleton or via another element that makes it possible to determine the presence and the relative position of at least some elementary solids with respect to each other.

According to the invention, a method for computer-assisted design of a mechanical assembly is proposed which comprises at least a step of graphic modeling of the mechanical assembly, which is three-dimensional and drivable by several elementary solids which can be parameterized, by the user, at least geometrically, independently form each other, wherein an elementary solid comprises a geometric structure that can be parameterized, by a user, at least geometrically, and represents a portion of a part or the removal of a portion of a part, a part being a structure, all the portions of which are immobile with respect to each other; characterized in that the parameterizable geometric structures of the elementary solids are generic for several mechanical assemblies distinct from each other while fulfilling a same function, wherein the parameterization of said structures can differ from one mechanical assembly to another, and in that the elementary solids, on the one hand, and the graphical model, on the other hand, are stored in files that are distinct and linked to each other so that said graphical model remains drivable by said elementary solids, so that it is easier for the user to re-use said generic geometric structures.

Advantageously, the graphical model file contains, neither parameters from constraints imposed by the environment of the mechanical assembly, nor parameters from constraints imposed by the operation of the mechanical assembly, nor parameters from constraints imposed by the manufacturing process of the mechanical assembly. All these parameters are then integrated in the design upstream of the graphical model. From one given mechanical assembly to another given mechanical assembly, which is distinct but fulfills the same function, all the constraints or nearly all the constraints are integrated upstream of the graphical model, which greatly simplifies the operation of the graphical model, especially during successive iterations in the design process.

The elementary solids of the group are advantageously three-dimensional elements, respectively. At this stage, usually downstream of the design process, it is interesting to have the precise three-dimensional shape of the various parts of the mechanical assembly be integrated. Several elementary solids represent part portions, respectively, and several other elementary solids represent removals of part portions, respectively. Thus, the elementary solids can account for all the volume variations, wherein the positive elementary solids bring material corresponding to part portions, while the negative elementary solids remove material, which corresponds most often to machining phases of the part.

Preferably, some geometric parameters of at least some elementary solids are driven by geometric parameters of a skeleton, whereas no geometric parameter of the skeleton is driven by the geometric parameters of the elementary solids. Thus, only the upstream phase of the design drives the downstream phase, and not the opposite. A design method structured in this way is more efficient.

The skeleton can be preferably displayed in the form of a group of points and/or straight lines and/or planes, to the exclusion of volumes. Thus, at this upstream stage, what is integrated is mainly positions and sizes of the parts, whereas their precise three-dimensional shape is taken into consideration only later in the design process, at the stage of the elementary solids.

Preferably, at least one elementary solid comprises one or several relationships representative of dependency links between parameters within this same elementary solid. At a stage further downstream in the design process, interactions between parameters that are more localized are thus taken into account, i.e., at the stage of a part portion or at the stage of a machining phase, for example.

Preferably, the parameters of the elementary solids include parameters from constraints imposed by the manufacturing process of the mechanical assembly. That is, it is interesting to integrate these parameters in a downstream phase of the design. Advantageously, the parameters of the elementary solids from constraints imposed by the manufacturing process of the mechanical assembly constitute a majority of the whole group of parameters from constraints imposed by the manufacturing process of the mechanical assembly. It is even more interesting to have most of these parameters integrated into this downstream phase of the design.

Preferably, the parameters of the elementary solids include parameters from constraints imposed by the environment of the mechanical assembly. Preferably, the parameters of the elementary solids include parameters from constraints imposed by the operation of the mechanical assembly.

In an optional embodiment, at least one assembly of elementary solids is structured in the form of an assembly of functional slices, a functional slice being itself an assembly of elementary solids. This hierarchical manner of assembling the elementary solids is particularly interesting in the case of a complex mechanical assembly, such as, for example, a land motor vehicle engine block.

Preferably, the order of assembly of the elementary solids reflects the prioritization of the steps of the manufacturing process of the part or parts of the mechanical assembly. The more the order of assembly of the elementary solids reflects the prioritization of the steps of the manufacturing process, the more the elementary solids will provide a good compromise between simplicity and genericity.

Preferably, the mechanical assembly belongs to a land motor vehicle.

Preferably, the elementary solids are driven by a skeleton. In this case, advantageously, the method for computer-assisted design of a mechanical assembly comprises at least a step of graphic modeling of the mechanical assembly, which is three-dimensional and drivable by a skeleton which comprises a geometric structure that can be parameterized, by a user, at least geometrically, and that defines the shape and the position of under-assemblies of the mechanical assembly; wherein the parameterizable geometric structure of the skeleton is generic for several mechanical assemblies distinct from each other and fulfilling a same function, wherein the parameterization of said structure can differ from one mechanical assembly to another, and the skeleton and the graphical model are stored in files that are distinct and linked to each other so that said graphical model remains drivable by said skeleton so that it is easier for the user to re-use said generic geometric structure.

The skeleton comprises preferably one or several relationships representative of dependency links between parameters. This makes it possible to take into account more effectively the inter-dependency between the parameters, including at this upstream stage of the design.

The skeleton is preferably made from a dependency graph that prioritizes the parameters with respect to each other using the dependency links between parameters and that is common to all the mechanical assemblies that fulfill a same function. In this way, a skeleton can be obtained that is relatively simple, while still generic. The skeleton thus obtained, even though it is simple, can be used for a large number of mechanical assemblies that are distinct, even though they fulfill the same function. Advantageously, the prioritization of the parameters in the dependency graph reflects the prioritization of the design steps of the mechanical assembly. The more these two prioritizations are similar, the more the skeleton represents a good compromise between simplicity and genericity.

The skeleton exists at least for one component, a component being a group of parts disposed such that if one of the parts is modified in its position or in its structure, the position as well as the structure of the other parts of the component can be modified. The skeleton, at the level of the component, ensures a good genericity with time. That is, contrary to the above, it occurs relatively more frequently that the structure of a part is completely changed. However, preferably, none of the parts has a skeleton.

The invention will now be described in more details using the following drawings, given by way of illustrative and non-limitative examples, in which:

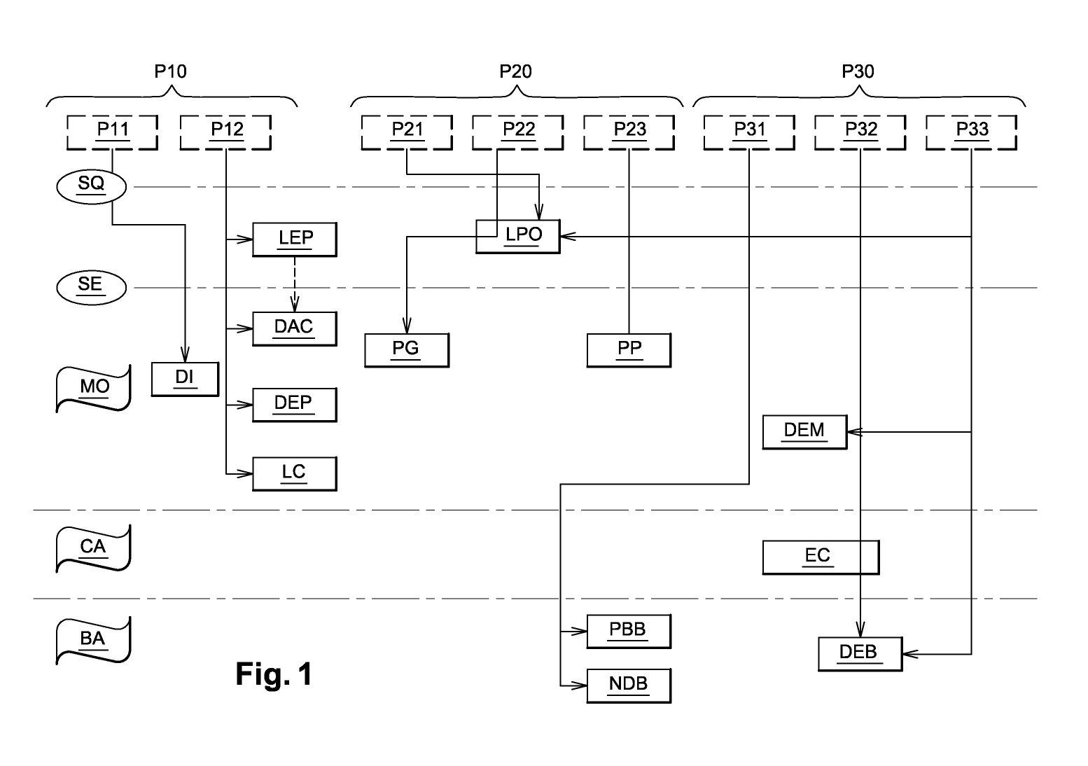

FIG. 1 represents schematically an example of a dependency graph for a pulley, according to a preferred embodiment of the invention;

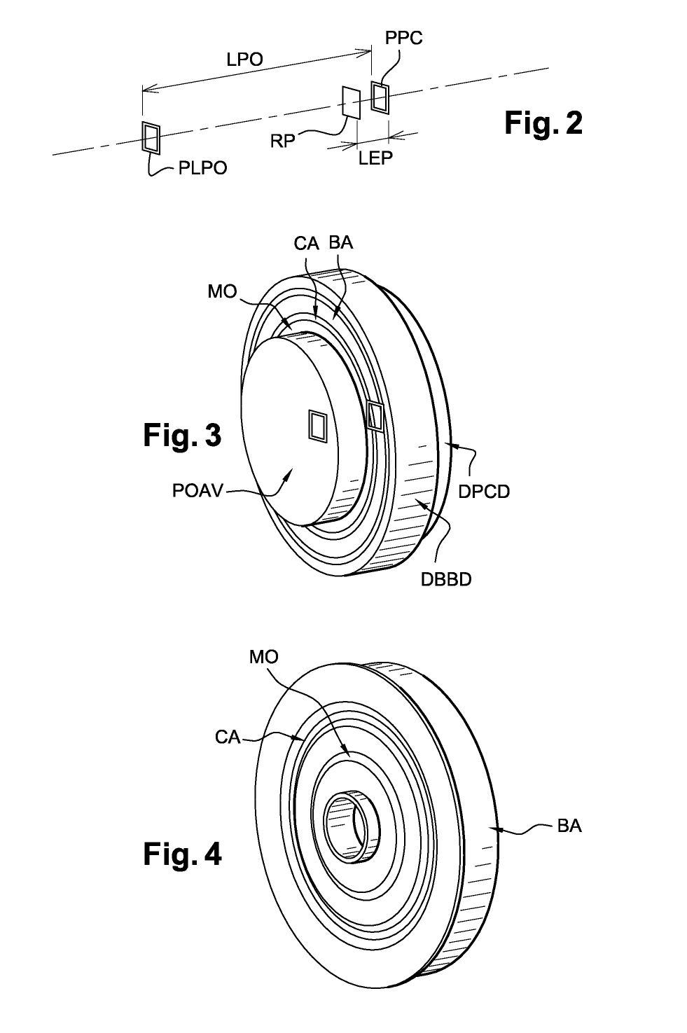

FIG. 2 represents schematically an example of a skeleton for a pulley according to a preferred embodiment of the invention;

FIG. 3 represents schematically an example of an assembly of elementary solids for a pulley according to a preferred embodiment of the invention;

FIG. 4 represents schematically an example of a non-parameterized graphical model of a pulley according to a preferred embodiment of the invention.

In order to illustrate the notions used above, a concrete example will now be studied, applied to a simple part. The part that has been chosen is the crankshaft vibration damper pulley, which is a part located at the end of the crankshaft in a shaft line of a motor vehicle engine. The first function of the crankshaft vibration damper pulley is to enable driving the belt of the engine accessories, in particular the alternator and the compressor. The second function of the crankshaft vibration damper pulley is to limit the non-cyclical operation of the engine. The crankshaft vibration damper pulley can be decomposed into three concentric parts that are layered successively along the radius of the pulley, from the center toward the periphery: the hub, which is the central part fixed to the crankshaft, the rubber, which is the intermediate part disposed around the hub, and the dynamic mass damper, which is the peripheral part disposed around the rubber, and on which the belt is wound. To illustrate clearly the complexity of the links between parameters, a description of the whole crankshaft would be useful, in terms of the dependency graph and skeleton as well as in terms of elementary solids. However, for reasons of simplicity and ease of understanding, the dependency graph, the skeleton and the elementary solids are presented only in connection with the crankshaft vibration damper pulley. For examples of more complex mechanical assembly, one can mention the crankshaft or the engine block.

FIG. 1 represents schematically an example of a dependency graph for a pulley according to a preferred embodiment of the invention. The skeleton layer SQ has only two parameters, the shoulder width LEP and the pulley width LPO. By contrast, the elementary solids layer has more numerous parameters. Among them, some elementary solids concern the hub MO, others the rubber CA, and still others the mass damper BA. Among the parameters concerning the hub MO, one can mention the inner diameter DI, the assembly DAC comprising the diameter and the bezel angle for contact with the distribution pinion, the shoulder diameter DEP, the key width LC, the assembly PG comprising the groove parameters, i.e., depth, lower diameter, upper diameter, and bezel angle, the assembly PP comprising the pocket parameters, the hub outer diameter DEM. Among the parameters concerning the rubber CA, one can mention the rubber thickness EC. Among the parameters concerning the mass damper BA, one can mention the mass damper outer diameter DEB, the group PPB comprising the mass damper stop parameters, the number of teeth of the mass damper NDB.

Parameters exterior to the pulley influence the parameters of the pulley, which are thus dependent on these exterior parameters. Among these exterior parameters, some belong to the family P10 of parameters coming from constraints imposed by the environment of the pulley, while others belong to the family P20 of parameters coming from constraints imposed by the manufacturing process of the pulley, and still others belong to the family P30 of parameters coming from constraints imposed by the operation of the pulley. The family P10 of parameters coming from constraints imposed by the environment of the pulley includes in particular the parameter P11 coming from the crankshaft, the parameter P12 coming from the distribution pinion. The family P20 of parameters coming from constraints imposed by the manufacturing process of the pulley includes in particular the parameter P21 coming from the proximity of the support arms, the parameter P22 coming from the proximity of the distribution block, the parameter P23 coming from the post-sale service tool kit. The family P30 of parameters coming from constraints imposed by the operation of the pulley includes in particular the parameter P31 coming from the distribution belt, the parameter P32 coming from the driving ratio with the alternator, the parameter 33 coming from the inertia. The arrows in uninterrupted line represent dependencies from exterior parameters. The arrows in interrupted line represent relationships among parameters. The directions of the arrows in the dependency graph correspond to the prioritization of the design steps of the pulley. The dependency graph is common to all the crankshaft vibration damper pulleys of different vehicles.

FIG. 2 represents schematically an example of a skeleton for a pulley according to a preferred embodiment of the invention. The skeleton has an axis, i.e., the axis of the crankshaft, on which are represented three planes, the plane PLPO which is the width plane of the pulley, the plane RP which is the referential plane of the pulley, the plane PPC which is the travel plane of the key. The distance between the plane PLPO and the plane PPC represents the pulley width parameter LPO. The distance between the plane RP and the plane PPC represents the shoulder width parameter LEP. The skeleton is common to all the crankshaft vibration damper pulleys of different vehicles, i.e., only its parameterization can vary from one crankshaft vibration damper pulley to another. The skeleton with its parameters and the graphical model are stored in files that are distinct from each other, but that remain linked so that the graphical model remains drivable by the skeleton.

FIG. 3 represents schematically an example of an assembly of elementary solids for a pulley according to a preferred embodiment of the invention. Three elementary solids correspond to portions of a part, i.e., the hub MO, the rubber CA, the dynamic mass damper BA. Four elementary solids correspond to removal of portions of the part, i.e., the cut in the area of the distribution block DPCD, the end cut of the dynamic mass damper DBBED, the passage for post-sale service tool kit POAV, the passage for the key, which is not shown here because it is applied to the hidden face of the pulley. The group of the usable elementary solids is common to all the crankshaft vibration damper pulleys of various vehicles, but the choice of some elementary solids, the manner of assembling them, and their parameterization can vary from one crankshaft vibration damper pulley to another. The elementary solids with their parameters, on the one hand, and the graphical model, on the other hand, are stored in files that are distinct from each other, but that remain linked so that the graphical model remains drivable by the elementary solids. In the preferred embodiment shown in the Figures, comprising a skeleton and elementary solids, the non-parameterized graphical model remains drivable by the elementary solids, which are in turn drivable by the skeleton. The skeleton with its parameters, on the one hand, and the elementary solids with their parameters, on the other hand, are stored in files that are distinct from each other, but that remain linked to each other so that the elementary solids remain drivable by the skeleton. More precisely, the parameterized skeleton drives the assembly of the parameterized elementary solids, which in turn drive the non-parameterized graphical model.

FIG. 4 represents schematically an example of a non-parameterized graphical model of a pulley according to a preferred embodiment of the invention. After assembly of all the above-mentioned elementary solids, the non-parameterized graphical model of the pulley after machining is obtained, on which one can identify the hub MO after machining, obtained by assembly of the elementary solid hub MO, the elementary solid cut in the area of the distribution block DPCD, and the elementary solid passage for post-sale service tool kit POAV. One can also identify the rubber CA, after machining, obtained by assembly of the elementary solid rubber CA and the elementary solid cut in the area of the distribution block DPCD. Further, one can also identify the dynamic mass damper BA after machining, obtained by assembly of the elementary mass damper BA, the elementary solid cut in the area of the distribution block DPCD, and the elementary solid end cut of the dynamic mass damper DBBD. The graphical model of a crankshaft vibration damper pulley is unique for a given crankshaft vibration damper pulley; a crankshaft vibration damper pulley that is different will have a different graphical model.

1. Method for computer-assisted design of a mechanical assembly comprising at least:
a step of graphic modeling of the mechanical assembly, which is three-dimensional and drivable by several elementary solids (SE) which can be parameterized, by the user, at least geometrically, independently from each other, wherein an elementary solid comprises a geometric structure that can be parameterized, by a user, at least geometrically, and represents a portion of a part or the removal of a portion of a part, a part being a structure, all the portions of which are immobile with respect to each other;
wherein the parameterizable geometric structures of the elementary solids are generic for several mechanical assemblies distinct from each other and fulfilling a same function, wherein the parameterization of said structures can differ from one mechanical assembly to another,
and wherein the elementary solids, on the one hand, and the graphical model, on the other hand, are stored in files that are distinct and linked to each other so that said graphical model remains drivable by said elementary solids, so that it is easier for the user to re-use said generic geometric structures.

2. Design method according to claim 1, wherein the elementary solids of the group are three-dimensional elements, respectively.

3. Design method according to claim 1, wherein several elementary solids represent part portions, respectively, and several other elementary solids represent removals of part portions, respectively.

4. Design method according to claim 1, wherein some geometric parameters of at least some elementary solids are driven by geometric parameters of a skeleton, and no geometric parameter of the skeleton is driven by the geometric parameters of the elementary solids.

5. Design method according to claim 1, wherein the skeleton can be displayed in the form of a group of points and/or straight lines and/or planes, to the exclusion of volumes.

6. Design method according to claim 1, wherein at least one elementary solid comprises one or several relationships representative of dependency links between parameters within this same elementary solid.

7. Design method according to claim 1, wherein at least one assembly of elementary solids is structured in the form of an assembly of functional slices, a functional slice being itself an assembly of elementary solids.

8. Design method according to claim 1, wherein the order of assembly of the elementary solids reflects the prioritization of the steps of the manufacturing process of the parts of the mechanical assembly.

9. Design method according to claim 1, wherein the parameters of the elementary solids include parameters from constraints imposed by the environment of the mechanical assembly.

10. Design method according to claim 1, wherein the parameters of the elementary solids include parameters from constraints imposed by the operation of the mechanical assembly.

11. Design method according to claim 1, wherein the parameters of the elementary solids include parameters from constraints imposed by the manufacturing process of the mechanical assembly.

12. Design method according to claim 1, wherein the parameters of the elementary solids from constraints imposed by the manufacturing process of the mechanical assembly constitute a majority of the group of parameters from constraints imposed by the manufacturing process of the mechanical assembly.

13. Design method according to claim 1, wherein the mechanical assembly belongs to a land motor vehicle.

14. Design method according to claim 1, wherein the graphical model file contains neither parameters from constraints imposed by the environment of the mechanical assembly, nor parameters from constraints imposed by the operation of the mechanical assembly, nor parameters from constraints imposed by the manufacturing process of the mechanical assembly.

15. Design method according to claim 1, wherein said step of graphic modeling is drivable by a skeleton which comprises a geometric structure that can be parameterized, by a user, at least geometrically, and that defines the shape and the position of under-assemblies of the mechanical assembly, wherein the parameterizable geometric structure of the skeleton is generic for several mechanical assemblies distinct from each other and fulfilling a same function, wherein the parameterization of said structure can differ from one mechanical assembly to another, and the skeleton and the graphical model are stored in files that are distinct and linked to each other so that said graphical model remains drivable by said skeleton so that it is easier for the user to re-use said generic geometric structure, wherein the skeleton can drive the elementary solids of the assembly.

16. Design method according to claim 1, wherein the skeleton comprises one or several relationships representative of dependency links between parameters.

17. Design method according to claim 16, wherein the skeleton is made from a dependency graph that prioritizes the parameters with respect to each other using dependency links between parameters and that is common to all the mechanical assemblies that fulfill a same function.

18. Design method according to claim 1, wherein the prioritization of the parameters in the dependency graph reflects the prioritization of the design steps of the mechanical assembly.

19. Design method according to claim 1, wherein the skeleton exists at least for one component, a component being a group of parts disposed such that if one of the parts is modified in its position or in its structure, the position as well as the structure of the other parts of the component can be modified.

20. Design method according to claim 1, wherein none of the parts has a skeleton.
